(19) United States
(12) Patent Application Publication
(10) Pub. No.: US 2009/0050338 A1
(43) Pub. Date: Feb. 26, 2009

(54) FIRE HOOD

(76) Inventor: Laurence Keith Kovacs, West Midlands (GB)

Correspondence Address: SMITH-HILL AND BEDELL, P.C., 16100 NW CORNELL ROAD, SUITE 220, BEAVERTON, OR, 97006, US

(21) Appl. No.: 11/909,957

(22) PCT Filed: Mar. 29, 2006
(86) PCT No.: PCT/GB2006/001144

§ 371 Date: Sep. 9, 2008

(30) Foreign Application Priority Data
Mar. 29, 2005 (GB) 0506173.4

(51) Int. Cl. A62C 3/00; F21V 25/12

(52) U.S. Cl. 169/54; 362/380

(57) ABSTRACT

A fire hood for a lighting assembly, the hood comprising a pocket formed from a fabric carrying a metal and plastics and/or rubber material coating, the pocket shaped to close an opening in a surface in use to act as a fire barrier across the opening, the metal and plastic and/or rubber coating providing a closed heat conductive interface surface for dissipation of heat without apertures for convective or other vented air cooling through the pocket.

The present invention relates to fire enclosures and more particularly to enclosures about such fittings as downlighters, lumiare type fittings and loud speakers located in ceilings or other surfaces of a building.

It is known to provide downlighters in ceilings of buildings in which a lamp is presented to provide lighting. However, these downlighters may be considered a potential source of fire ignition, and the apertures through which the downlighter is presented are at least potential breaks in structural fire barriers utilised in building design to provide for fire containment. Generally, this containment should provide a barrier for a fixed period such as sixty minutes.

Previously, downlighter apertures have been closed during fires by the expansion of intumescent materials or materials coated in intumescent material. Thus, UK patent application 2391023 and 0416337.4 show arrangements for downlighter assemblies using intumescent materials. It will be understood that intumescent materials are relatively expensive and will require cutting to an appropriate size with positioning of the intumescent material such that it will close the apertures with sufficient robustness and rapidity for acceptable performance in terms of creating a fire barrier. It Will also be understood that with respect to downlighters, the downlighter lamp itself during normal operation will become relatively hot and therefore previous systems allowed for air flow convection cooling about the assembly. It will also be understood in certain circumstances, it is necessary to consider acoustic and environmental proofing in terms of dust and water ingress. The intumescent material is effectively utilised in order to swell in use for blocking up conduits for cabling as well as extending across the apertures through which the downlighter is presented and ventilated. All these factors have significantly added to overall cost for each downlighter incorporating fire barrier protection.

In accordance with the present invention there is provided a fire hood for a lighting assembly, the hood comprising a pocket formed from a fabric carrying a metal and plastics and/or rubber material coating, the pocket shaped to close an opening in a surface in use to act as a fire barrier across the opening, the metal and plastic and/or rubber coating providing a closed heat conductive interface surface for dissipation of heat without apertures for convective or other vented air cooling through the pocket.

Generally, the opening is a mounting aperture for a light assembly or other heat generating device.

Normally, the metal is aluminium. Normally, the plastics material is polyurethane.

Typically, the pocket defines a pocket opening for association with the mounting aperture through which a heat generating device such as a light assembly extends so that the pocket encapsulates the heat generating device. Possibly, the pocket opening has flaps for securing about the mounting aperture. Generally, the pocket opening is sealed about the mounting aperture. Typically, such sealing is by a silicone resin sealant and/or intumescent paint.

Generally, the pocket also provides an environmental barrier in terms of water proofing and/or acoustic resistance across the mounting aperture.

Typically, the fabric has a weight in the range 150 to 400 grams per square metre, preferably 200 gsm. Generally, the fabric has a thickness of 0.15 to 0.4 millimetres, preferably 0.2 millimetres. Preferably, the fabric is coated on both sides with aluminium/polyurethane coating material in order to provide a consistent heat conductive interface across the pocket.

Generally, the pocket is formed by stitching. Normally, the stitching is provided by stainless steel and/or Kevlar thread.

Advantageously, the pocket is associated with a thermo reactive portion to provide a colour change indicative of higher than expected temperature. Generally, the thermo reactive portion is provided as a patch stuck or sewn upon the pocket.

Possibly, the pocket has an excess expansion indicator for indication of higher than expected temperature. Typically, the excess expansion indicator comprises a rupturable thread extending across a fold in the pocket.

Normally, the pocket has a fixing sleeve for fixings to allow the pocket to be presented about the mounting aperture. Generally, the fixing in use hooks upon one end of the fixing sleeve. Additionally, the pocket includes reinforcing elements. Typically, the reinforcing elements comprise an insert in a reinforcing sleeve formed in the pocket.

Embodiments of the present invention will now be described by way of example and with reference to the accompanying drawings in which:

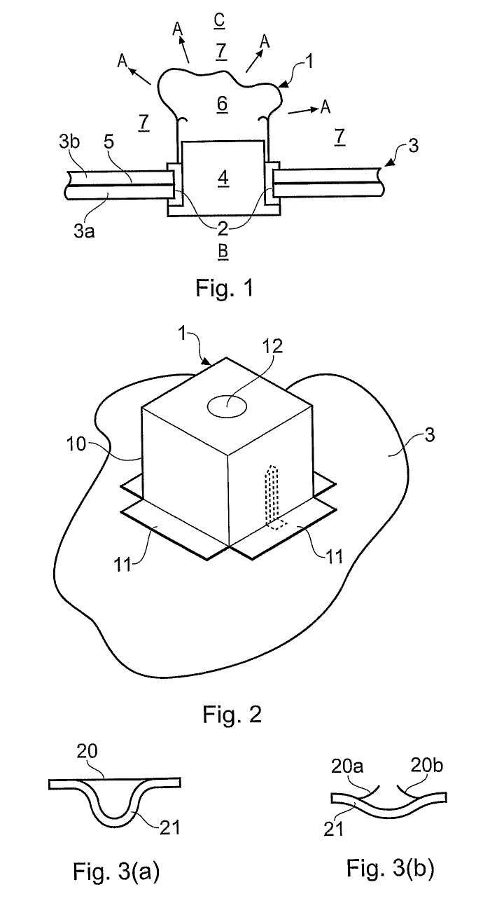

FIG. 1 is a schematic cross section of a fire hood associated with a mounting aperture and heat generating light fitting;

FIG. 2 is a schematic perspective view of a fire hood in accordance with the present invention; and,

FIG. 3 is a schematic depiction of an indicator of excess expansion in a fire hood in accordance with the present invention.

The essential problem with respect to apertures in a ceiling or other surface in a building is that this aperture breaches the fire barrier utilised for fire containment. In such circumstances, as described above, previously intumescent material has been used to close these apertures in order to give a rated time period of fire barrier containment. Intumescent materials were used in view of the previously considered necessary provision of ventilation apertures for convective air cooling in normal use from a heat generating device such as a downlighter or lumiare fitting. It will be understood that these downlighter fittings in normal operation generate considerable heat as a bi-product of electrical illumination. It will also be understood that loudspeakers can be accommodated and these will generate heat.

The present invention provides a fire hood in which there are no ventilation apertures for convective air cooling. Heat dissipation is provided through ensuring that the pocket from which the fire hood is formed is coated with a heat conductive coating as a heat dissipation interface. This heat conductive coating is a combination of a metal and plastics and/or rubber material such as aluminium and polyurethane, although another conductive metal and plastics material could be used. In such circumstances, without provision of ventilation apertures for convective air cooling, there is sufficient heat dissipation through the interface provided by the aluminium/polyurethane coating to ensure that the light fitting remains within acceptable operational parameters.

FIGS. 1 and 2 illustrate respectively a schematic cross section of a fire hood 1 extending across a mounting aperture 2 in order to close the mounting aperture 2 in a mounting surface 3 in which a heat generating device such as a light fitting 4 or loud speaker is secured. The device 4 is connected to electrical cabling 5 in order to power the lamp and the hood 1. The pocket as formed extends about this cable 5 and around the aperture 2. The pocket of the hood 1 is typically stitched in order to provide an enclosure to receive the device 2 such that it is encapsulated on all sides except through the aperture 2 in order to provide illumination or other function. The pocket of the hood 1 essentially provides a bag surrounding the device 2 and it is not necessary that this pocket has any fixed structural form or integrity other than creating a barrier across the aperture 2 in order to form a fire barrier of sufficient performance to provide the necessary time period of protection.

It will be understood in normal use the heat generating device 4 will generate heat such that this heat must be dissipated. Within the pocket of the hood 1 there will be the device 4 as well as some captured air 6. This air 6 as well as device 4 will heat and it is by providing an aluminium/polyurethane coating to the pocket of the hood 1 that it is possible to dissipate this heat energy at a sufficient rate to ensure that the device 4 remains within acceptable operational parameters. The aluminium/polyurethane coating creates a heat conductive interface between the interior, that is to say the device 4 and air 6 and the exterior 7 about the hood 1. As indicated, the cavity air 6 will become heated and therefore will expand and contract dependent upon heat generated by the device 4. This will expand and contract the pocket of the hood 1 such that the available surface area of the thermo conductive interface may expand and contract similarly. In any event, heat is radiated in the direction of arrowheads A through the aluminium/polyurethane coating such that externally as a result of air convection there is adequate cooling as indicated in order to retain the device 4 within acceptable thermal operating parameters for normal use. However, should a fire develop in the area B or for that matter in the area C, the pocket of the fire hood 1 presents a closure to the mounting aperture 2 such that there is sufficient fire barrier of sufficient durability.

Typically, the fire hood 1 in accordance with the present invention will be secured in a ceiling between two layers 3a, 3b of plaster board. Each of these layers 3a, 3b may have a thickness in the order of 9 to 15 millimetres so that there may be a combined thickness of 18-30 mm. The aperture 2 is formed in the layers 3a, 3b and may have a diameter in the range 70 to 130 millimetres, dependent upon the size of the device 4 to be secured in this mounting aperture 2. The hood is fitted over the top of the device 2 either on the upper surface of the layer 3b or possibly sandwiched between the device 4 sidewalls and the ends of the layers 3a, 3b or even with lateral slats sandwiched between the layers 3a, 3b. In any event, as indicated, the hood 1 creates an encapsulating enclosure about the device 4 and more importantly acts as a fire barrier closing the mounting aperture 2. There are no apertures or holes in the hood 1, and as indicated therefore the hood 1 is a solid barrier.

The fire hood i depends upon the aluminium/polyurethane coating in order to provide a sufficient thermally conductive interface for heat dissipation in normal use by the device 4. In such circumstances, the pocket of the hood 1 is formed from an appropriate material coated with the aluminium/polyurethane coating. This material is generally a woven fabric and normally a glass fibre woven fabric of appropriate weft and warp weave. It is found that a fabric in the range 150 to 400 grams per square metre is acceptable, but it will be understood that the fabric weight is dependent upon the stiffness of hood required. Normally, the fabric weight will be around 200 grams per square metre. The fabric will generally have a thickness in the range 0.15 to 0.4 millimetres with preferably a thickness in the order of 0.2 millimetres, again dependent upon the flexibility of the hood required. Normally, in order to create an adequate thermally conductive interface both sides of the fabric are coated with the aluminium/polyurethane coating.

As indicated above, the pocket of the hood 1 is typically formed from an appropriately cut sheet of material stitched or stuck together in order to create a pocket for securing about the mounting aperture 2. The pocket of the hood 1 may be round or oval, but for constructive purposes it has been found that a box shape is preferable. FIG. 2 provides a perspective view of the hood 1. As can be seen, sides 10 of the hood 1 are secured together by stitching and generally the stitch flaps will be arranged through folding out of the hood 1 during manufacture such that they are internally presented, that is to say on the captive air 6 side depicted in FIG. 1. This will be more aesthetically pleasing as viewed externally and where a sealant is provided between the stitching flaps, it will be understood that in such circumstances this sealant will generally be forced towards the stitching rather than away from the stitching.

The hood 1 has securing flaps 11 which extend laterally and allow the hood 1 to be secured to a mounting surface 3. These mounting flaps 11 may be secured by any appropriate means including as described above by sandwiching between mounted surface layers 3a, 3b. More normally, the mounting flaps 11 will be secured by a silicone or intumescent paint against the mounting surface 3. However, tags or other means of securing the flaps to the surface 3 may be used.

It will be understood that in most situations there will be a relatively large number of downlighter assemblies or otherwise in the surface 3 such that a fire hood in accordance with the present invention will be secured about each downlighter or other heat generating device 4 (FIG. 1). It will also be understood that the hood may be simply secured across a simple opening in a surface such as a ceiling. In such circumstances where access is available, such as in a roof space, it may be advantageous to allow the temperature cycling of the heat emitting device to be monitored. In such circumstances, as depicted in FIG. 2, a thermo reactive portion 12 may be provided. This portion 12 will change colour to indicate a higher than expected temperature within the hood 1. This colour change may be from green to red or otherwise, but in any event by a simple visual inspection of the portion 2 it may be possible to determine whether the temperature within the assembly is higher than expected and therefore whether maintenance or other investigations are required. Normally, the portion 12 will be provided by a stick or sewn on patch secured to the fire hood 1.

It will be understood that the fire hood 1 in accordance with the present invention presents as indicated a continuous barrier about the mounting aperture 2 such that access to the device 4 for maintenance may be restricted from the side C depicted in 1. In such circumstances, it may be desirable to allow the hood 1 to be removed for maintenance. This may be achieved by provision of means for release of the flaps 11. Thus, rather than completely sealing or nailing down the flaps 11, a weighted element may be secured over the flap 11 and this weighted element may comprise a unitary ring which extends around the hood 1 and is simply put into place by slipping that ring over the hood 1 to rest upon the flaps 11.

A further, although more rudimentary indicator of high temperatures may be by consideration of excessive expansion of the air 6 within the fire hood 1. In order to indicate that expansion as shown in FIG. 3, an excess expansion indicator may be provided. This excessive expansion indicator may comprise a thread 20 which extends across a fold 21 in a wall of the hood 1. This thread 20 is rupturable such that as the hood expands, the fold as indicated in FIG. 3 expands outwardly to accommodate the air 6 expansion with excess temperature and the thread 20 ruptures into parts 20a, 20b. In such circumstances, a visual inspection will indicate that the hood has expanded excessively and this may be provided as an indicator that maintenance is required or consideration must be taken with regard to the size of hood provided for a particular installation.

Generally, it is preferable that the hood 1 is integrated with the other mounting means for the device 4 in use. In such circumstances, the hood 1 incorporates fitting sleeves in the form of flaps of material secured to the inner surface of the hood 1 within which fixing brackets can be secured. Normally, one end of the fixing bracket will have a hook which extends over an open end of the mounting sleeve whilst another end has a jaw arrangement comprising one fixed jaw to abut one side of the surface 3 and an axially variable jaw which can be brought into contact with the other side of the surface 3 such that the fixing bracket upon which the hood 1 is secured acts. Such an arrangement is described in U.K. patent application nos. 0216915.9 and 0416337.4. Generally, two fixing brackets will be used to secure the hood 1 in use.

As indicated above, it is not necessary that the fire hood 1 presents a rigid structure, but if necessary this may be partially achieved through use of a sufficient weight and/or thickness of fabric material with coating. Nevertheless, where an open nature is desirable for the hood 1, then reinforcing sleeves may be provided in the sidewalls of the hood 1 in a similar fashion to the fixing sleeves described above. Thus, open ended sleeves will be formed in the side walls of the hood 1 and reinforcing members introduced in these sleeves such that the combination creates a reinforcing element within the hood 1.

As the fire hood 1 presents a continuous barrier across the mounting aperture 2, it will be appreciated that the hood 1 also provides an environmental barrier in terms of water proofing at least. Furthermore, as the fire hood 1 is essentially flaccid it will be understood that a degree of acoustic resistance may be achieved through this flaccid nature absorbing acoustic noise which may be transmitted through the mounting aperture 2.

Alterations and modifications to the present invention will be appreciated by those skilled in the technology. Thus, for example, rather than aluminium another conductive metal, such as copper, may be utilised with plastics materials or rubber other than polyurethane in order to create the thermally conductive interface across the material as a fire barrier whilst allowing normal heat generating device operation. Additionally, the fire hood may be formed from layers of coated material where desirable. It will also be understood that the fire hood may simply extend across a hole or opening in the surface whether created deliberately or as a result of removing any device normally mounted in the mounting aperture or opening but no longer required and a temporary closure may not provide a sufficiently robust fire barrier.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-24. (canceled)

25. A fire hood for a lighting assembly, the hood comprising a pocket formed from a fabric carrying a metal and plastics and/or rubber material coating, the pocket shaped to close an opening in a surface in use to act as a fire barrier across the opening, the metal and plastic and/or rubber coating providing a closed heat conductive interface surface for dissipation of heat without apertures for convective or other vented air cooling through the pocket.

26. A hood as described in claim 25 wherein the opening is a mounting aperture for a lighting assembly or other heat generating device.

27. A hood as claimed in claim 25 wherein the metal is aluminium.

28. A hood as claimed in claim 25 wherein the plastics material is polyurethane.

29. A hood as claimed in claim 25 wherein the pocket defines a pocket opening for association with the opening in use through which a heat generating device such as a lighting assembly extends in use so that the pocket encapsulates the heat generating device.

30. A hood as claimed in claim 29 wherein the pocket opening has flaps for securing about the opening in use.

31. A hood as claimed in claim 29 wherein the pocket opening forms a seal for association with the opening use.

32. A hood as claimed in claim 31 wherein the seal is a silicone resin sealant and/or intumescent paint.

33. A hood as claimed in claim 25 wherein the pocket provides an environmental barrier in terms of water proofing and/or acoustic resistance across the opening.

34. A hood as claimed in claim 25 wherein the fabric has a weight in the range 150 to 400 grams per square metre, preferably 200 gsm.

35. A hood as claimed in claim 25 wherein the fabric has a thickness of 0.15 to 0.4 millimetres, preferably 0.2 millimetres.

36. A hood as claimed in claim 25 wherein the fabric is coated on both sides with aluminium/polyurethane coating material in order to provide a consistent heat conductive interface across the pocket.

37. A hood as claimed in claim 25 wherein the pocket is formed by stitching.

38. A hood as claimed in claim 37 wherein the stitching is provided by stainless steel and/or Kevlar thread.

39. A hood as claimed in claim 25 wherein the pocket is associated with a thermo reactive portion to provide a colour change indicative of higher than expected temperature.

40. A hood as claimed in claim 39 wherein the thermo reactive portion is provided as a patch stuck or sewn upon the pocket.

41. A hood as claimed in claim 25 wherein the pocket has an excess expansion indicator for indication of higher than expected temperature.

42. A hood as claimed in claim 41 wherein the excess expansion indicator comprises a rupturable thread extending across a fold in the pocket.

43. A hood as claimed in claim 25 wherein the pocket has a fixing sleeve for fixings to allow the pocket to be presented about the opening in use.

44. A hood as claimed in claim 43 wherein the fixing in use hooks upon one end of the fixing sleeve.

45. A hood as claimed in claim 25 wherein the pocket includes reinforcing elements.

46. A hood as claimed in claim 45 wherein the reinforcing elements comprise an insert in a reinforcing sleeve formed in the pocket.
